(19) United States
(12) Patent Application Publication
(10) Pub. No.: US 2020/0052259 A1
(43) Pub. Date: Feb. 13, 2020

(54) BATTERY MODULE WITH BOTTOM PLATE ON WHICH POSITIONING ELEMENTS ARE ARRANGED TO POSITION BATTERY CELLS

(71) Applicant: Tiveni MergeCo Inc., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wustenrot (DE); Claus Gerald PFLÜGER, Markgroningen (DE)

(21) Appl. No.: 16/536,153

(22) Filed: Aug. 8, 2019

Related U.S. Application Data
(60) Provisional application No. 62/716,676, filed on Aug. 9, 2018.

(51) Int. Cl. H01M 2/10

(52) U.S. Cl. CPC H01M 2/1077; H01M 2220/20

(57) ABSTRACT

In an embodiment, a battery module includes a bottom plate, and a set of positioning elements integrated into the bottom plate or attached to the bottom plate, the set of positioning elements arranged defining a cell fixation region where a bottom of a cylindrical battery cell interfaces with a surface of the bottom plate.

### CROSS-REFERENCE TO RELATED APPLICATIONS

The present Application for Patent claims the benefit of U.S. Provisional Application No. 62/716,676 with attorney docket no. TIV-180002P1, entitled “BATTERY MODULE WITH BOTTOM PLATE ON WHICH POSITIONING ELEMENTS ARE ARRANGED TO POSITION BATTERY CELLS AND METHOD OF ASSEMBLY”, filed Aug. 9, 2018, which is assigned to the assignee hereof and hereby expressly incorporated by reference herein in its entirety.

### BACKGROUND

### 1. Field of the Disclosure

Embodiments relate to a battery module with a bottom plate on which positioning elements are arranged to position battery cells.

### 2. Description of the Related Art

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are electrically connected (e.g., in series or in parallel) to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

### SUMMARY

n an embodiment, a battery module includes a bottom plate, and a set of positioning elements integrated into the bottom plate or attached to the bottom plate, the set of positioning elements arranged defining a cell fixation region where a bottom of a cylindrical battery cell interfaces with a surface of the bottom plate

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1A illustrates an example metal-ion (e.g., Li-ion) battery in which the components, materials, methods, and other techniques described herein, or combinations thereof, may be applied according to various embodiments.

FIG. 1B illustrates a high-level electrical diagram of an exemplary battery module that shows P groups 1 . . . N connected in series in accordance with an embodiment of the disclosure.

FIG. 2 illustrates a battery module during assembly.

FIG. 3 illustrates the battery module of FIG. 2 during a later point of assembly after battery cells are inserted into respective receptacles of a bottom cell fixation element.

FIGS. 4-16B illustrate a battery module assembly procedure in accordance with an embodiment of the disclosure.

FIG. 17 illustrates two variants of pin arrangements in an assembly device.

FIG. 18 illustrates a coordinate system (x, y, z) for battery cell arrangements.

FIG. 19 illustrates several positioning element arrangements in accordance with embodiments of the disclosure.

FIG. 20A illustrates an example of a 3-pin arrangement whereby each pin is glued onto the bottom plate in accordance with an embodiment of the disclosure.

FIG. 20B illustrates an example of a 3-pin arrangement whereby each pin is applied as part of a 3-pin ring that is glued onto the bottom plate in accordance with an embodiment of the disclosure.

FIG. 20C illustrates an example of a 3-pin arrangement whereby each pin is glued to the bottom plate along with glue that is further used to glue the battery cells onto the bottom plate.

FIGS. 21A-21J illustrates variants in terms of the fit and form of pins in association with a 6-pin arrangement in accordance with embodiments of the disclosure.

FIGS. 22A-22B illustrate an implementation whereby pins are used as tie rods via a welded connection (e.g., torsional welding) (FIG. 22A) or via a glued connection (FIG. 22B) in accordance with embodiments of the disclosure.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are electrically connected (e.g., in series or in parallel) to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

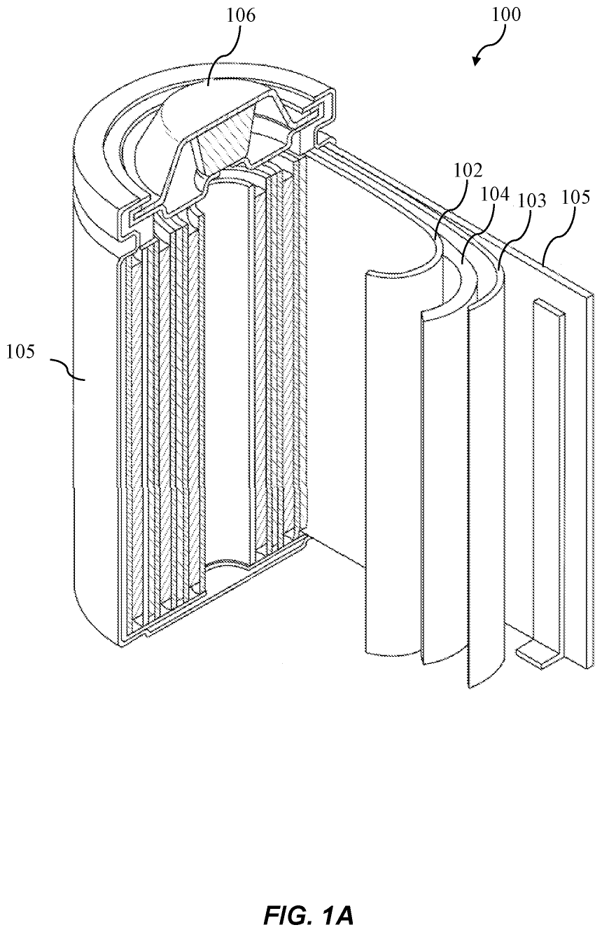

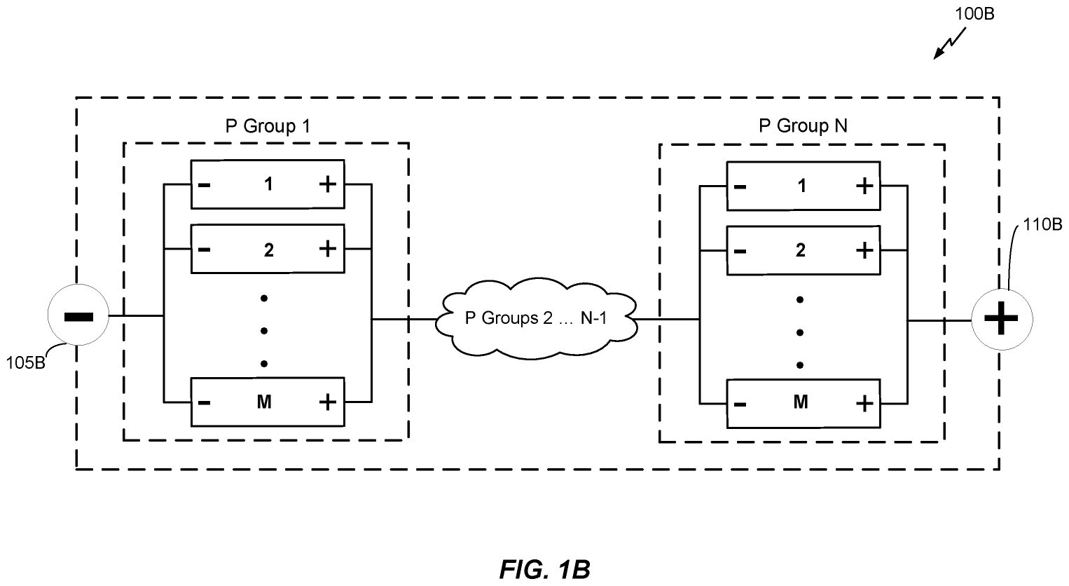

FIG. 1A illustrates an example metal-ion (e.g., Li-ion) battery in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

FIG. 1B illustrates a high-level electrical diagram of a battery module 100B that shows P groups 1 . . . N connected in series in accordance with an embodiment of the disclosure. In an example, N may be an integer greater than or equal to 2 (e.g., if N=2, then the intervening P groups denoted as P groups 2 . . . N−1 in FIG. 1 may be omitted). Each P group includes battery cells 1 . . . M connected in parallel. The negative terminal of the first series-connected P group (or P group 1) is coupled to a negative terminal 105B of the battery module 100B, while the positive terminal of the last series-connected P group (or P group N) is connected to a positive terminal 110B of the battery module 100B. As used herein, battery modules may be characterized by the number of P groups connected in series included therein. In particular, a battery module with 2 series-connected P groups is referred to as a “2S” system, a battery module with 3 series-connected P groups is referred to as a “3 S” system, and so on.

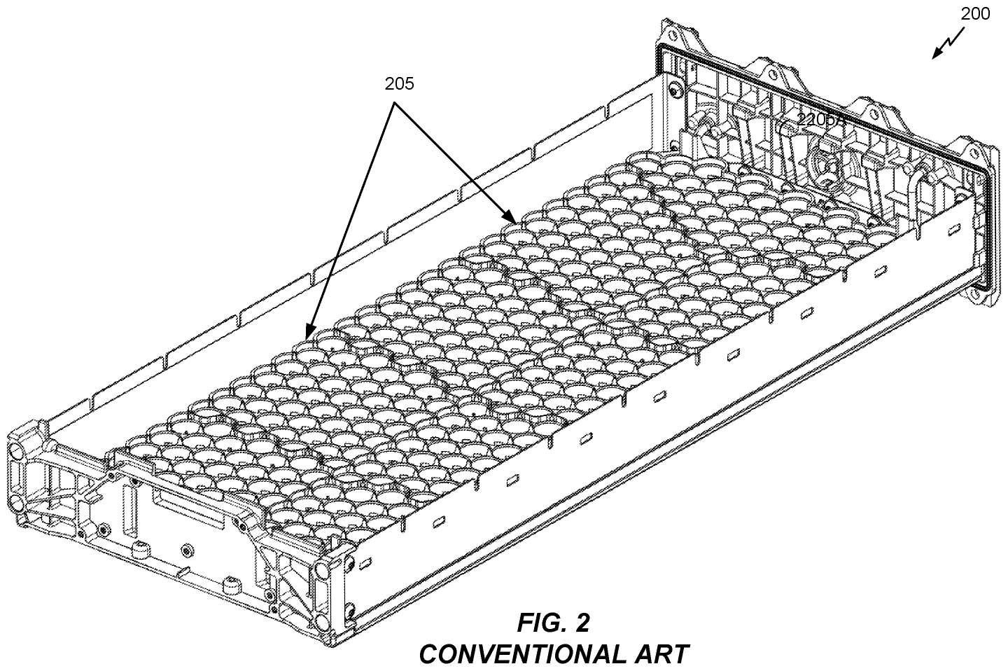

FIG. 2 illustrates a battery module 200 during assembly. In FIG. 2, a bottom cell fixation element 205 containing a plurality of battery cell receptacles for fixing a bottom part of cylindrical battery cells is shown. The bottom cell fixation element 205 may be arranged as a single large piece of plastic (or several joined pieces of plastic) that is inserted and secured (e.g., glued) to a bottom of the battery module 200. The bottom cell fixation element 205 may be arranged such that different contiguous clusters of receptacles correspond to different P Groups.

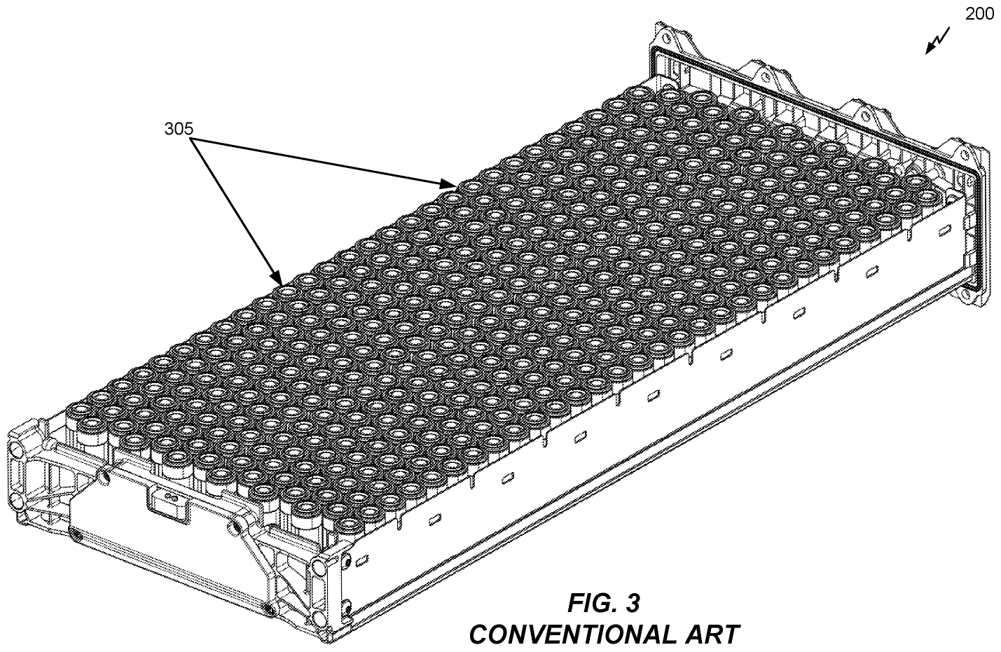

FIG. 3 illustrates the battery module 200 during a later point of assembly after battery cells 305 are inserted into the respective receptacles of the bottom cell fixation element 205. While not shown, a top cell fixation element (not shown) may be arranged over the battery cells 305, such that the battery cells 305 are substantially fixed (or secured) inside the battery module 200 via their attachment to the top cell fixation element 205 (not shown) and the bottom cell fixation element 205.

One drawback to the cell fixation arrangement depicted in FIGS. 2-3 is limited tolerance to crash forces. For example, assume that the battery module 200 is deployed in an electric vehicle that experiences crash forces. The individual battery cells 305 are securely held via the top cell fixation element 205 (not shown) and the bottom cell fixation element 205, which can cause stress and possible rupture to the battery cells 305 depending on the strength of the crash forces.

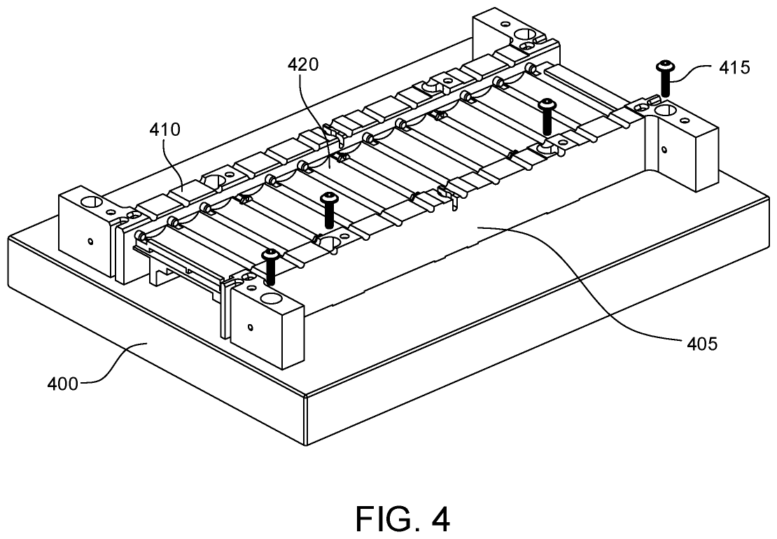

FIGS. 4-16B illustrate a battery module assembly procedure in accordance with an embodiment of the disclosure.

Referring to FIG. 4, the battery module begins construction on a base plate 400 onto which jigs 405-410 (plus side jig 405 and minus side jig 410) are mounted (e.g., via screws 415). The jigs are stackable, as will be discussed below in more detail. An external frame component 420 of the battery module is arranged between the jigs. As used herein, the “minus side” of the battery cell assembly refers to the side of the battery cell that opposes the positive terminal of the battery cell. For certain implementations, battery cells with positive and negative terminals arranged on the same side may be used (e.g., a positive cell head surrounded by a negative cell rim), in which case the “minus side” does not necessarily correspond to the negative terminal of a respective battery cell.

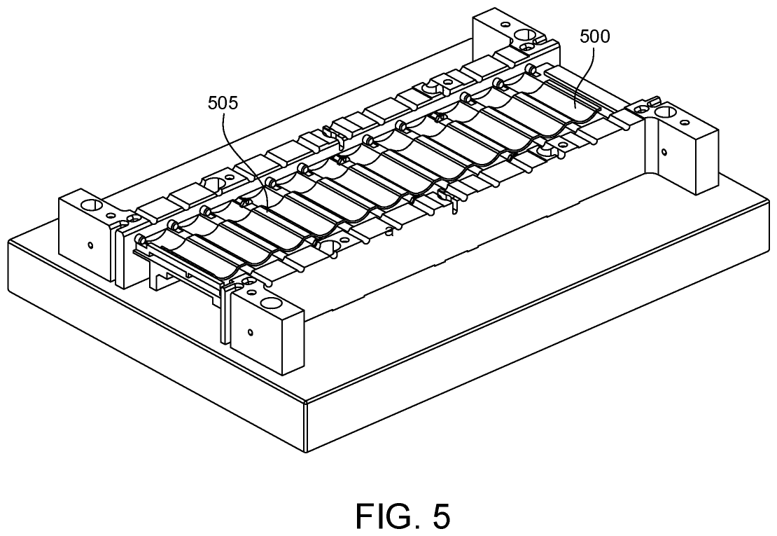

Referring to FIG. 5, an insulative layer 500 is glued onto the external frame component 420 via a dispensing machine 505.

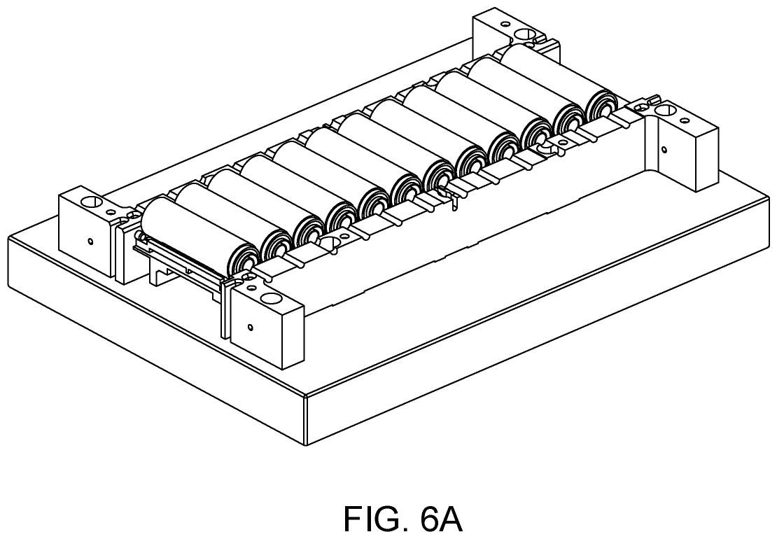

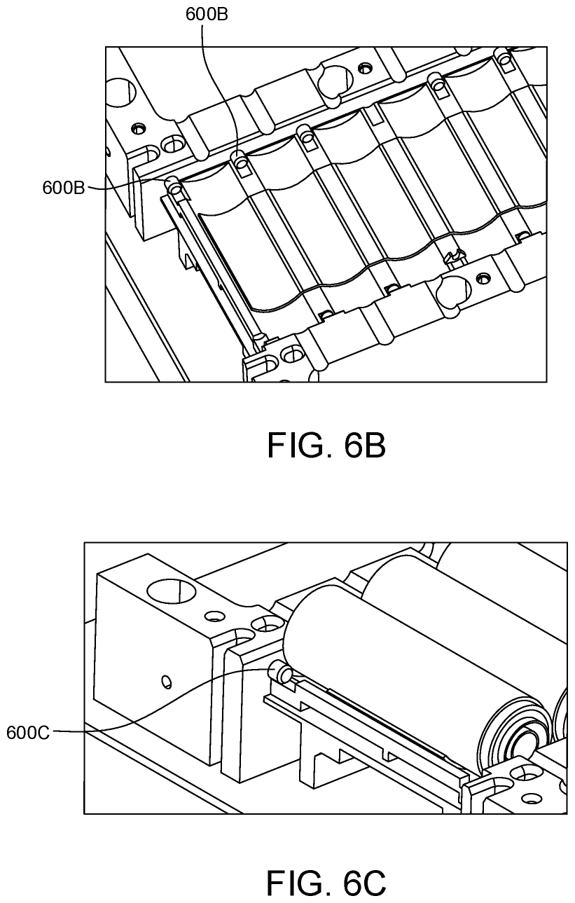

Referring to FIG. 6A, a cell layer 1 is placed onto the insulative layer. In the embodiment of FIG. 6A, the cell layer 1 includes 12 cylindrical battery cells that are each part of the same P Group. FIGS. 6B-6C demonstrate how pins 600B-600C arranged on the respective jigs can be used to fix the position of each cell in the cell layer 1. In an example, magnets may be integrated into each minus side jig to pull the respective cells of each cell layer so that the minus side of each cell layer is flush.

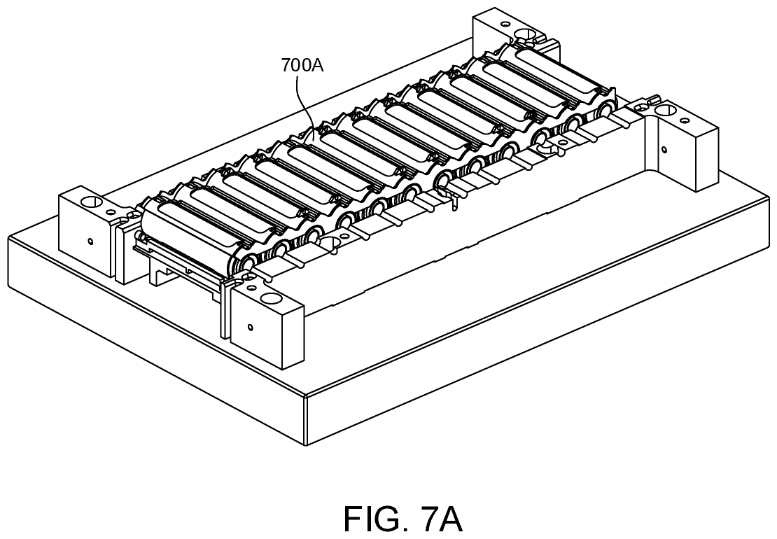

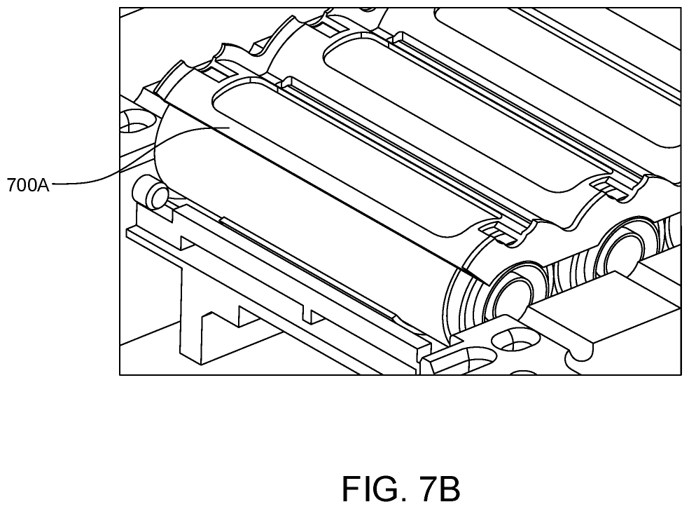

Referring to FIG. 7A, a spacer 700A is added on top of the cell layer 1. The spacer is arranged to define a spacing between the cell layer 1 and a cell layer 2 (not shown in FIG. 7A). In an example, the spacer 700A may comprise a piece or several pieces (e.g., made from plastic).

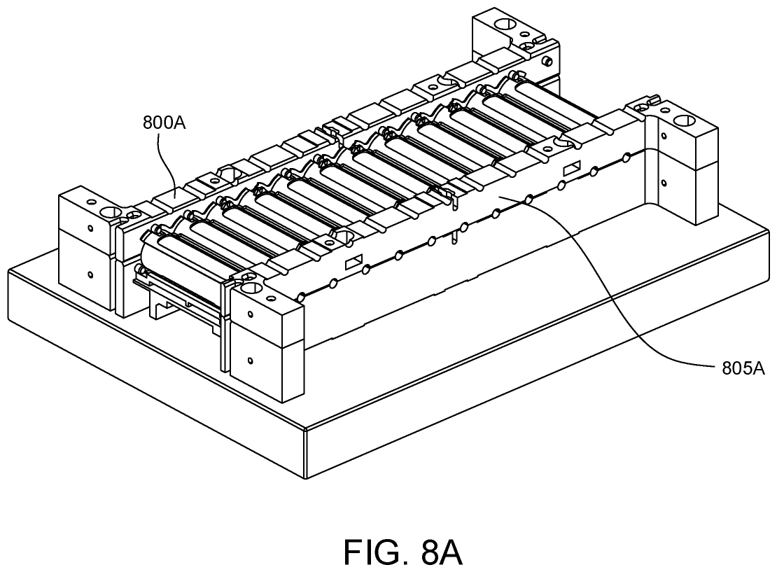

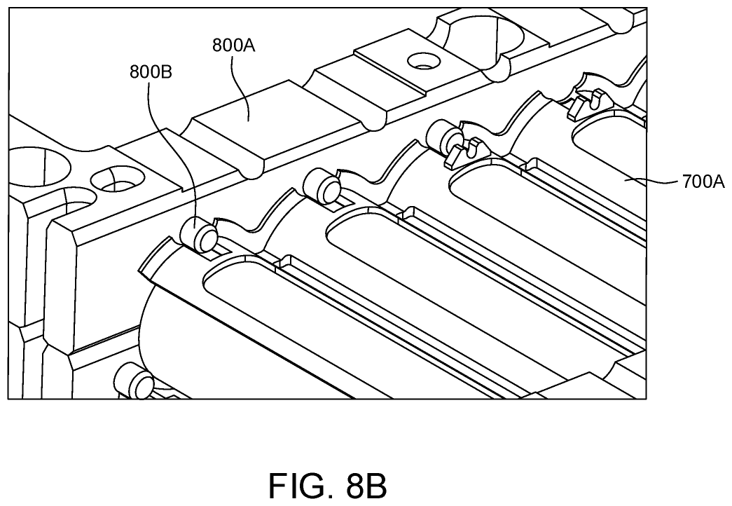

Referring to FIG. 8A, jigs 800A-805A (minus side jig 800A and plus side jig 805A) for the cell layer 2 are stacked onto the jigs 405A-410A for the cell layer 1. As shown more clearly in FIG. 8B, notches in the spacer 700A between cell layers 1 and 2 are aligned with pins 800B on the jigs for the cell layer 2.

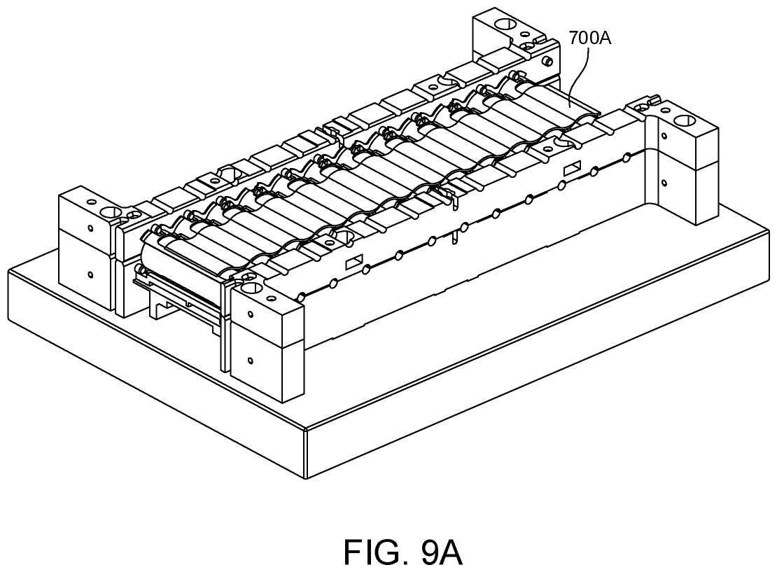

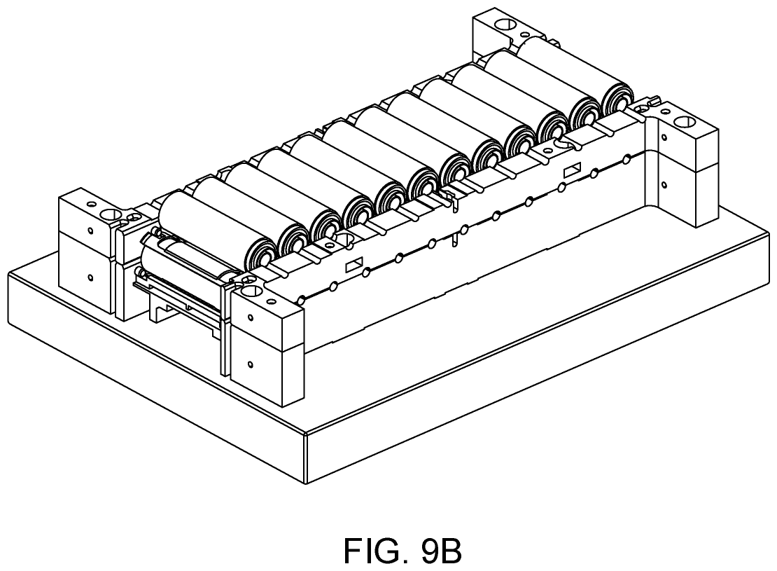

Referring to FIG. 9A, an insulative layer 900A is placed on the spacer 700A between cell layers 1 and 2. While not shown expressly in FIG. 9A, glue may be applied to the insulative layer.

Referring to FIG. 9B, the cell layer 2 is placed onto the insulative layer and secured via the glue. In the embodiment of FIG. 9B, the cell layer 2 includes 12 cylindrical battery cells that are each part of the same P Group. The P Group of cell layer 2 may be the same or different from the P Group of cell layer 3, depending on the configuration of contact plate(s) used in the battery module (described below in more detail).

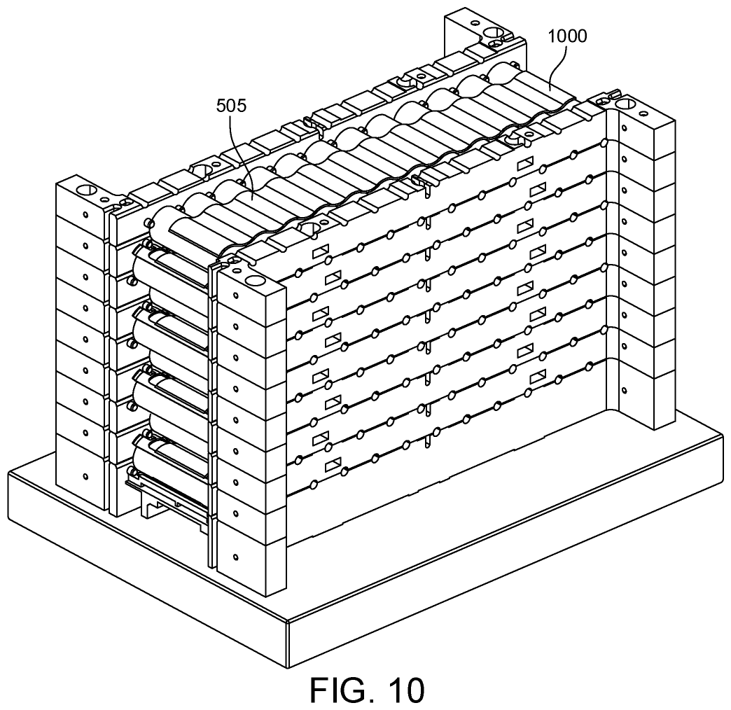

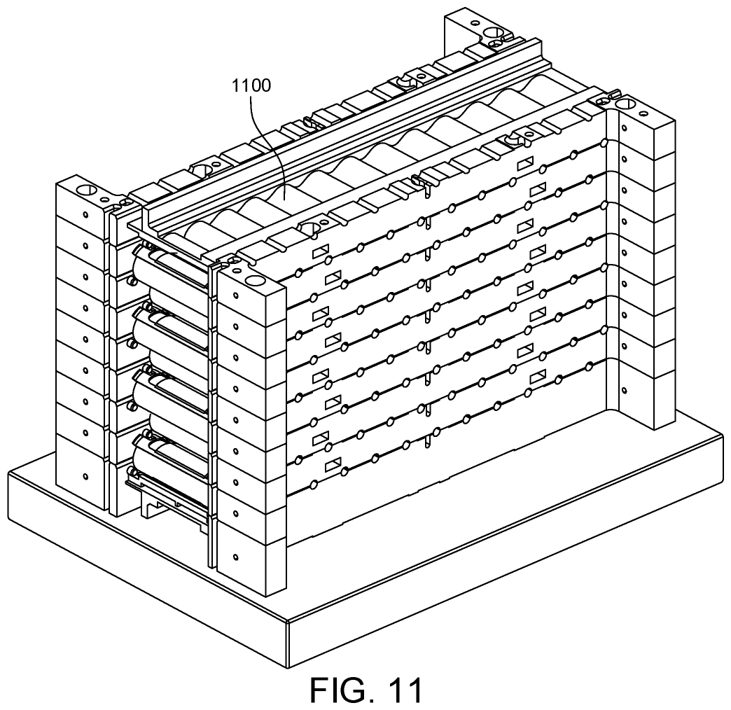

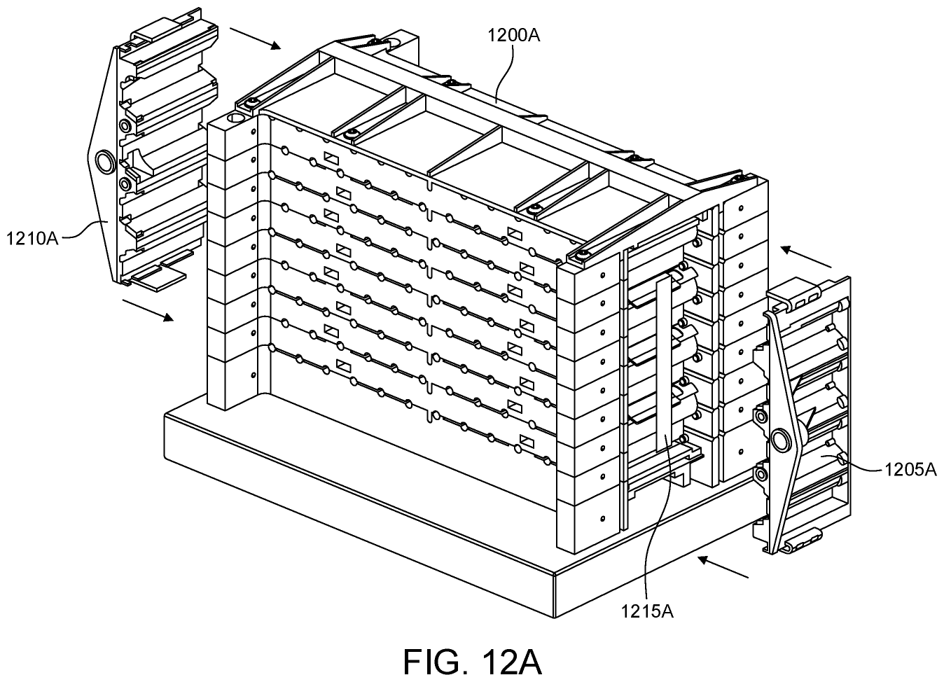

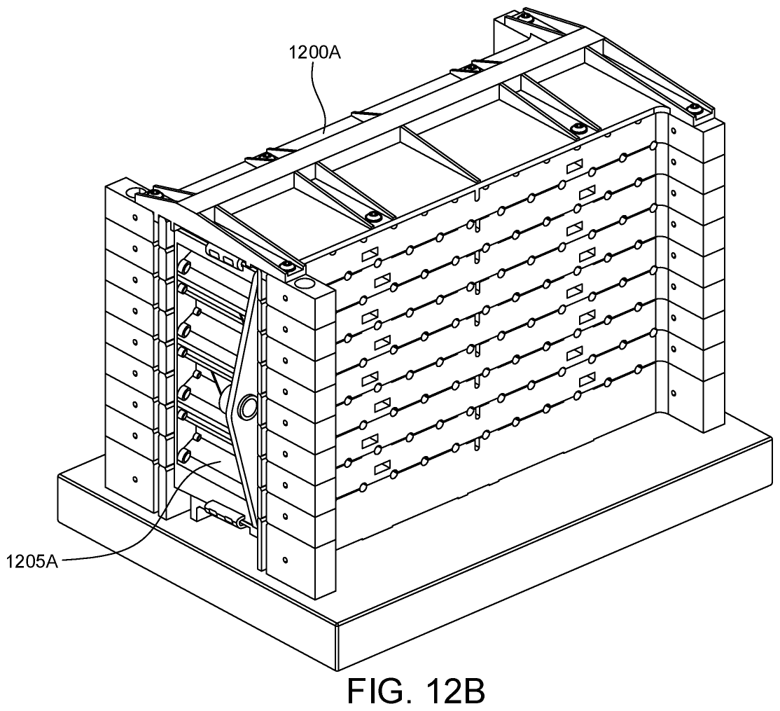

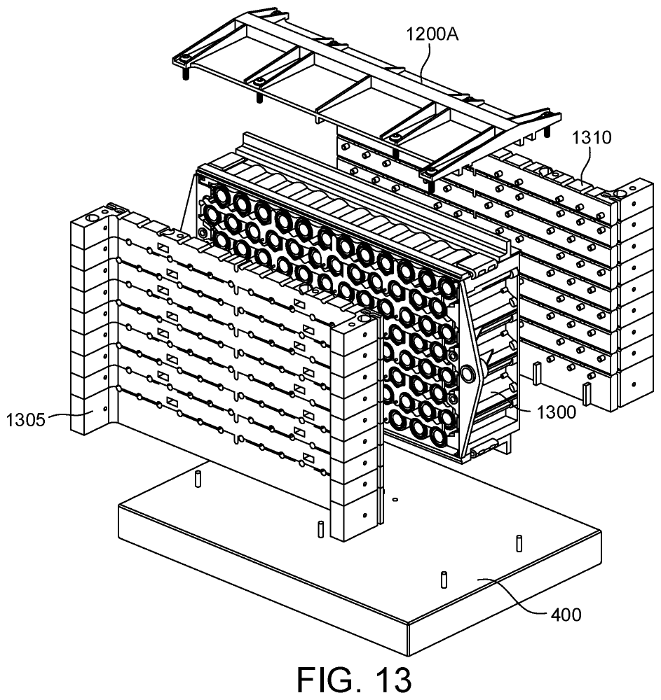

At this point, the processes depicted in FIGS. 7A-9B may repeat a given number of times until a desired number of cell layers are constructed, resulting in the arrangement depicted in FIG. 10 including cell layers 1-8. As shown in FIG. 10, glue is applied to the top-most insulative layer 1000, after which another external frame component 1100 is attached to the top-most insulative layer 1000 as shown in FIG. 11. As shown in FIGS. 12A-12B, a top jig 1200A is added, after which opposing sidewalls 1205A-1205A are attached via glue 1210A. The battery module 1300 is then separated from respective jig towers 1305-1310, top jig 1200A and the base plate 400 as shown in FIG. 13.

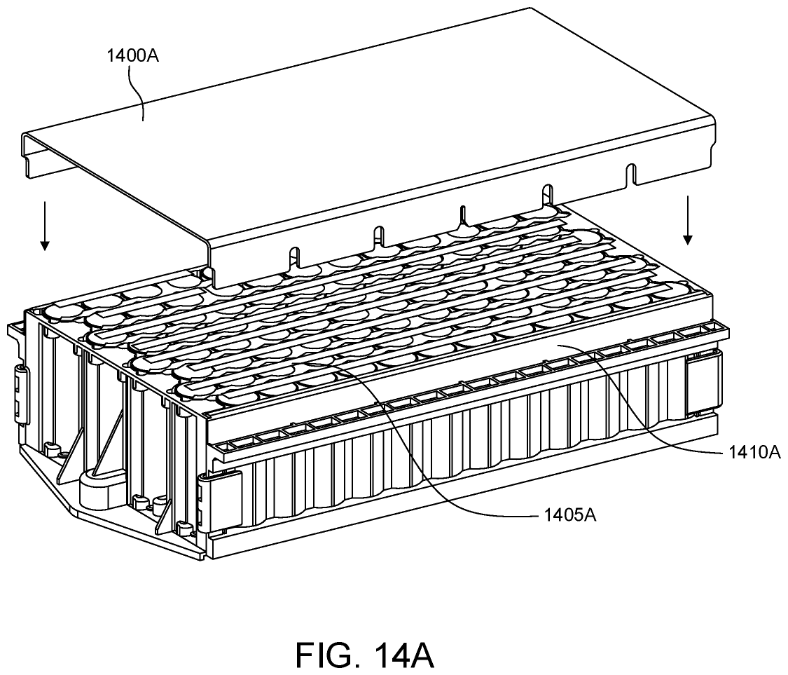

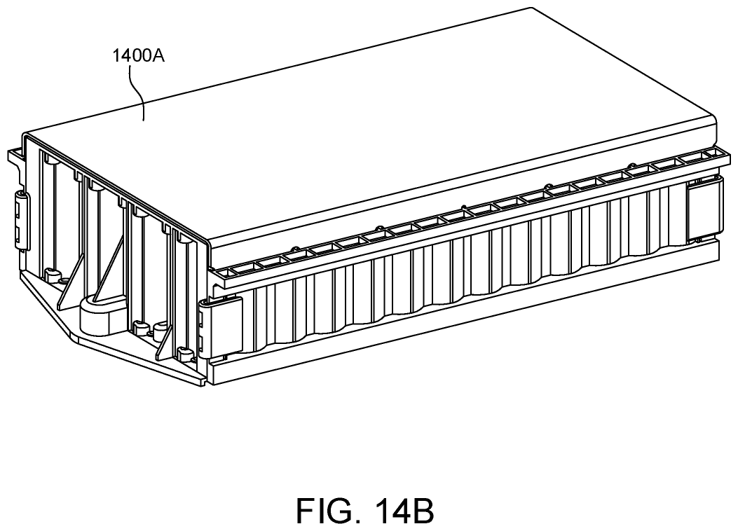

Referring to FIGS. 14A-14B, a bottom plate 1400A is secured to the battery module via glue 1405A arranged inside of respective slots 1410A.

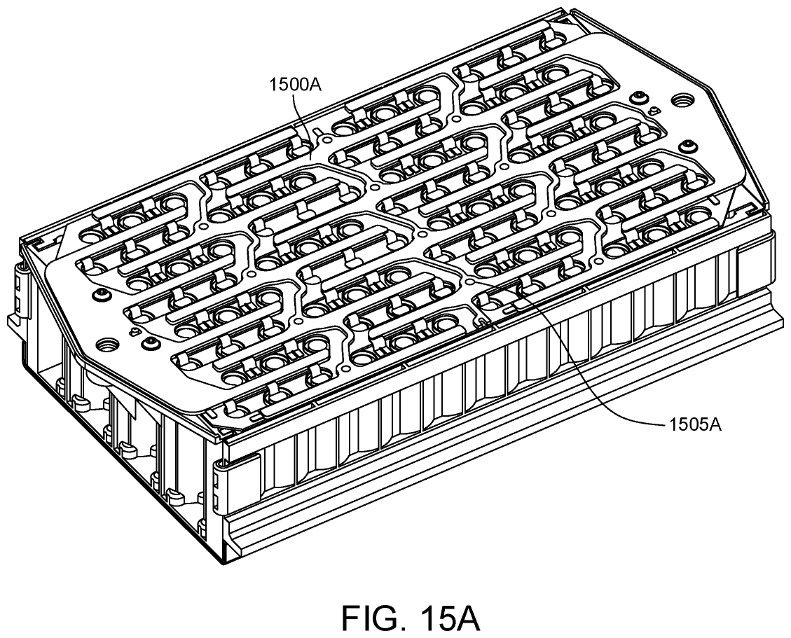

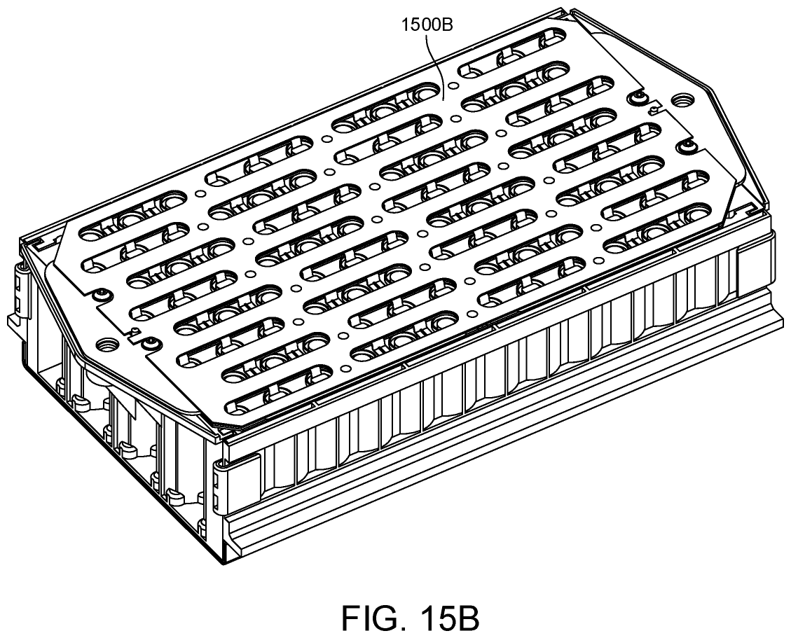

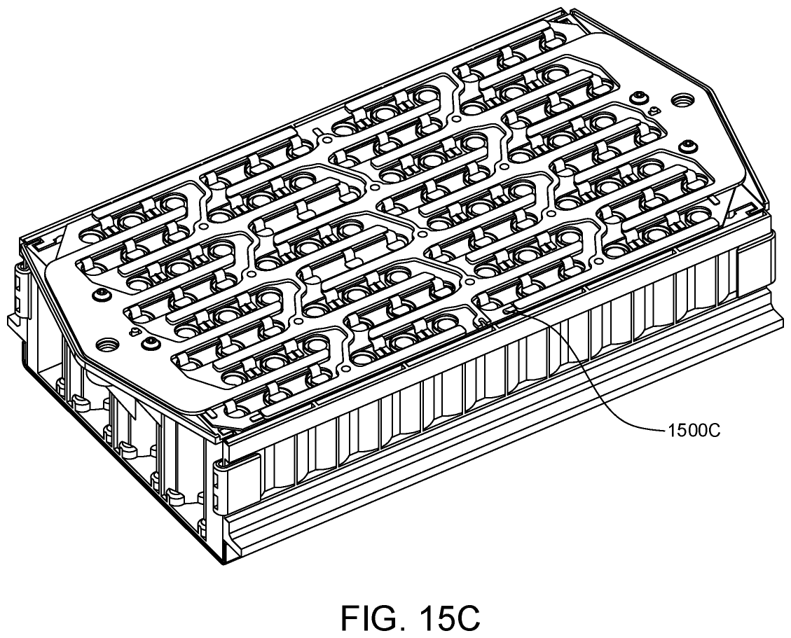

Referring to FIG. 15A, a conductive plate (or contact plate) 1500A is arranged over the battery cells (e.g., fixed with glue) of the battery module. In an example, the contact plate 1500A may be secured in place via glue 1505A. FIG. 15B depicts an alternative contact plate 1500B that comprises 2-layer foil. Examples of contact plates are described at least with respect to FIGS. 7A-8B of U.S. Patent Publication No. 2018/0108886A1, entitled “Multi-layer contact plate configured to establish electrical bonds to battery cells in a battery module”, and hereby incorporated by reference in its entirety. Referring to FIG. 15C, the contact plate of FIG. 15A may further include contact tabs 1500C onto which sensor wire may be connected (e.g., thermistors).

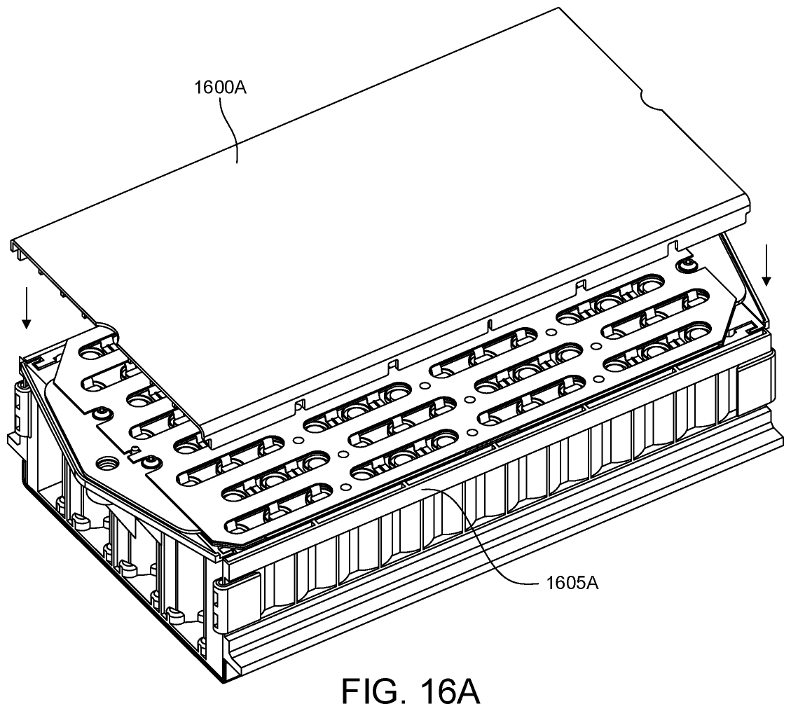

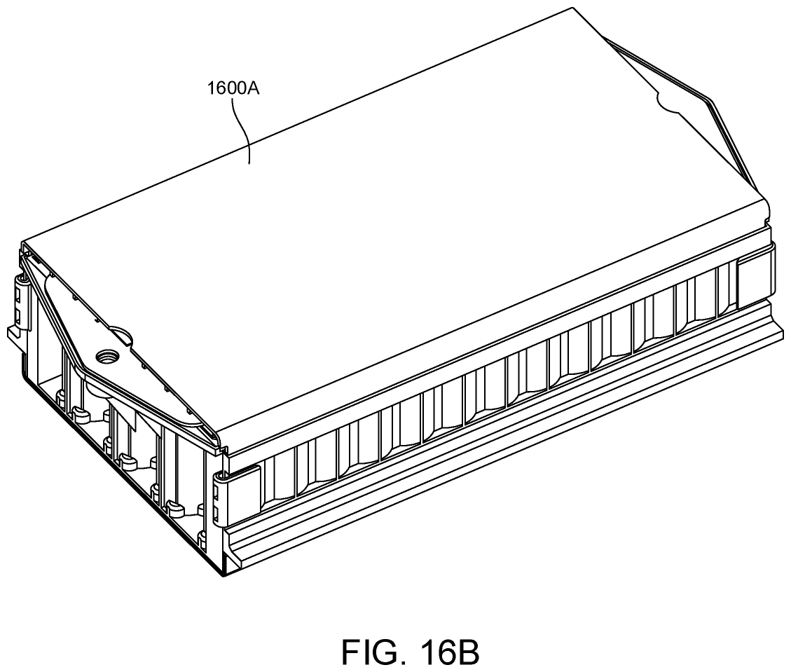

Referring to FIGS. 16A-16B, a cover (or top plate) 1600A is added to the battery module (e.g., via glue arranged within slots 1605A). At this point, the battery module is complete and may be deployed as part of an energy storage system (e.g., for an electric vehicle). The external parts of the battery module (e.g., external frame components, sidewalls, bottom plate and cover) collectively comprise a battery housing for the battery cells contained therein.

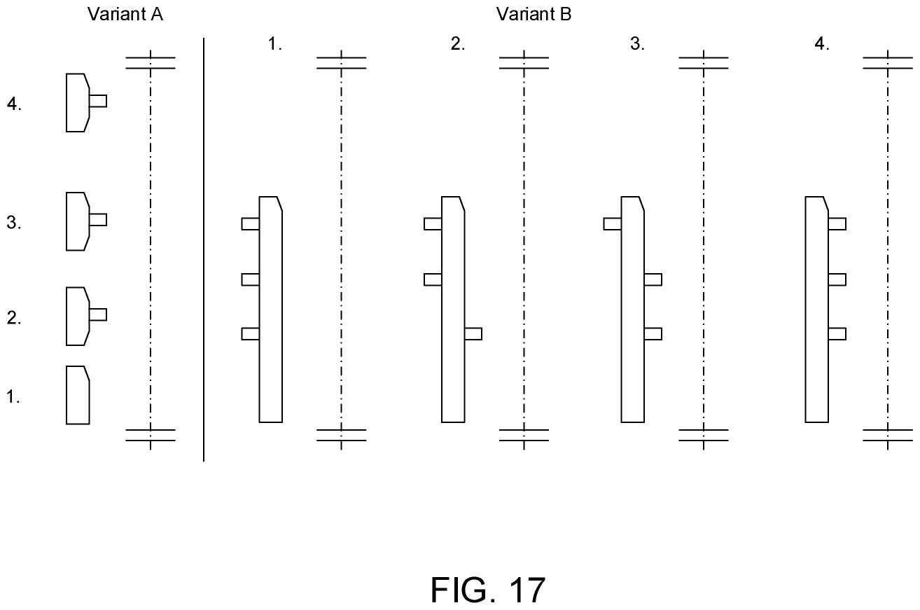

FIG. 17 illustrates two variants of pin arrangements in the assembly device (i.e., in the minus side and plus side jigs). The pins shown in FIG. 17 map to the pins that are aligned with inter-cell layer spacers, such as pins 800B being aligned with space 700A as shown in FIGS. 8A-8B.

In variant A, the pins are fixed on different jigs and are added when each new jig is added as illustrated in FIGS. 4-16B. In this case, respective jig towers successively increase in height as each new jig level is added. In variant B, a jig tower that comprises a plurality of stacked jigs and/or a single large structure (one large jig comprising multiple cell layers) is used, whereby pins can be set to a withdrawn position (not inserted) or an inserted position. In variant B(1), each pin of the jig tower is withdrawn. In variant B(2), the pin for cell layer 1 is inserted. In variant B(3), the pin for cell layers 1 and 2 are inserted. In variant B(3), the pin for cell layers 1-3 are inserted. As will be appreciated, the jig tower can span any number of cell layers, and multiple jig towers and/or individual jigs can be stacked together as well.

Referring to FIG. 18, a coordinate system (x, y, z) is defined for battery cell arrangements is defined. In an example, the battery cells depicted in FIG. 18 may correspond to a sampling of battery cells arranged in three adjacent cell layers during the process of FIGS. 4-17.

Embodiments of the disclosure are directed to positioning elements (e.g., pins) arranged inside a battery module (e.g., such as the battery module constructed in accordance with FIGS. 4-17) to control the position of battery cells of the battery module (e.g., during gluing of the battery cells while their position is still subject to disruption). For example, the positioning elements may be arranged on a surface of the bottom plate (e.g., cooling plate) of the battery module define a cell fixation region. In some designs, the positioning elements may also ensure a defined electrical isolation gap between the bottom plate and the battery cells. For example, the positioning elements may be integrated or attached to the bottom plate 1400A shown in FIG. 14A, such that when the bottom plate 1400A is mounted to the rest of the module frame (or battery housing), the battery cells are guided into proper position. As used herein, the ‘distance’ between the bottom plate and the bottom of the battery cells may refer to the absolute z-distance therebetween, while the ‘position’ of the battery cells refers to the absolute x-y-position of the battery cells relative to the bottom plate.

In an example, one advantage achieved by the positioning elements is to position the battery cells in a simple way in all three directions. For example, the set of positioning elements is configured to fix the cylindrical battery cell (in x, y and z directions) such that (i) one or more distances between the cylindrical battery cell and one or more adjacent cylindrical battery cells are controlled and (ii) a distance between the bottom of the cylindrical battery cell and a surface of the bottom plate is controlled (e.g., to ensure electrical isolation between the bottom of the cylindrical battery cell and the surface of the bottom plate, which may function as a cooling plate). The proposed arrangement may help to simplify assembly and reduce manufacturing equipment while also providing sufficient stiffness to handle the battery module in line while glue is hardening. Additional features such as a tie rod between upper and lower cover parts, an opening for dispensing glue and a form fit between a ring shaped undercut pin and cell by glue can also be integrated in certain embodiments.

In an embodiment, to improve energy density, the battery cells in the battery module may be arranged in a triangular manner with a distance of approximately the cell diameter from each cell to the adjacent cells. To position the cells, in an example, positioning elements (e.g., pins) may be arranged at three (or more) points around a circumference of each battery cell. The shell surface of the cell in contact with these three or more positioning elements defines the cell position in x- and y-direction. Further, in an example, three or more surface contact points between the bottom of the battery cell and the bottom plate may ensure the cell position in z-direction. In an example, direct surface contact points between the bottom of the battery cell and the bottom plate can be implemented if the bottom plate is insulative, or alternatively if the bottom plate is conductive (e.g., cooling plate) with an insulative coating arranged thereon. In other designs, the cell position between the bottom of the battery cell and the bottom plate may ensure the cell position in z-direction may be defined via a clamping device that secures the battery cell in position while being glued to the bottom plate (after hardening, the glue is sufficient to hold the battery cell in position). In other designs, mechanically strong objects may be arranged between the bottom of the battery cell and the bottom plate. In some designs, these mechanically strong objects may comprise insulative beads (e.g., glass spherical beads) mixed with a thermally conductive and electrically insulative paste (e.g., the weight of the battery cells will push down on the paste but will ultimately be stopped by the insulative beads, with the diameter of the beads defining the z-direction offset between the bottom of the battery cell and the bottom plate). As noted above with respect to FIGS. 4-17, improved contact (e.g., flush or substantially flush contact) between the bottom plate 1400A and the bottoms of the battery cells may be facilitated via the use of magnets in the minus side jigs.

In one embodiment, the number of positioning elements (e.g., pins) arranged around each battery cell may range between 3 pins and 6 positioning elements, with a substantially equal angular spacing between each respective positioning element. In an example, the positioning elements may be integrated into the bottom plate or alternatively may be attached to the bottom plate as separate components. In a further example, a tie rod between the top plate (or battery module cover) and the bottom plate may be used to further fix the battery cells in position (e.g., as a bolt connection).

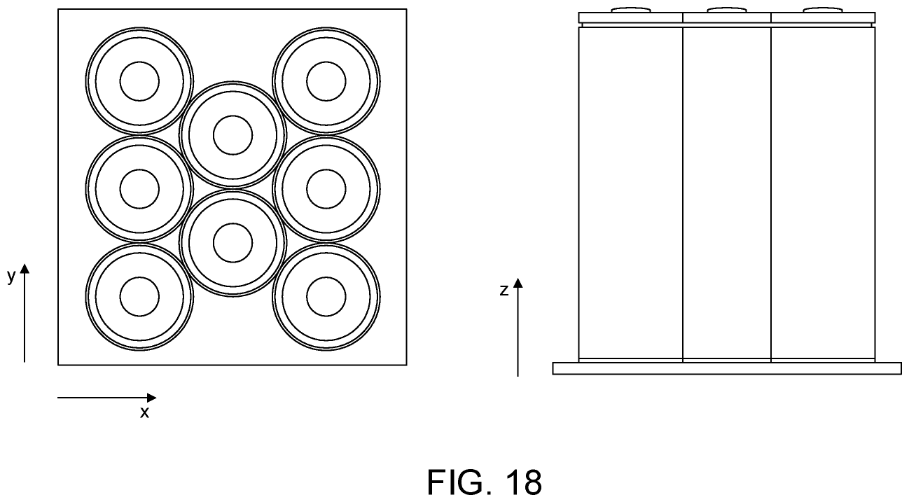

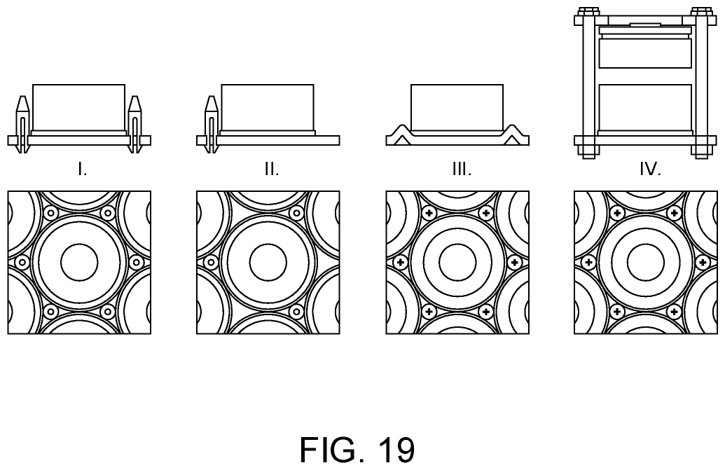

FIG. 19 illustrates several positioning element arrangements in accordance with embodiments of the disclosure. In particular, FIG. 19 depicts a (I) 6-pin arrangement, a (II) 3-pin arrangement, a (III) 6-pin direct-formed arrangement (e.g., pins integrated as part of bottom plate as indentations, which may be created by tacking in some designs) and a (IV) 6-element tie-rod arrangement via bolt connections.

In a further embodiment, the pin itself can be applied by glue to the bottom plate. In an example, the pin can be applied as a single pin or a ring with several pins or a perforated plate with several pins. Each arrangement can be completed with additional taps to ensure z-position. In an example, the glue used to secure the pins may also be used to secure the cells (i.e., without additional glue). In an alternative example, additional glue may be used to secure the cells to the bottom plate.

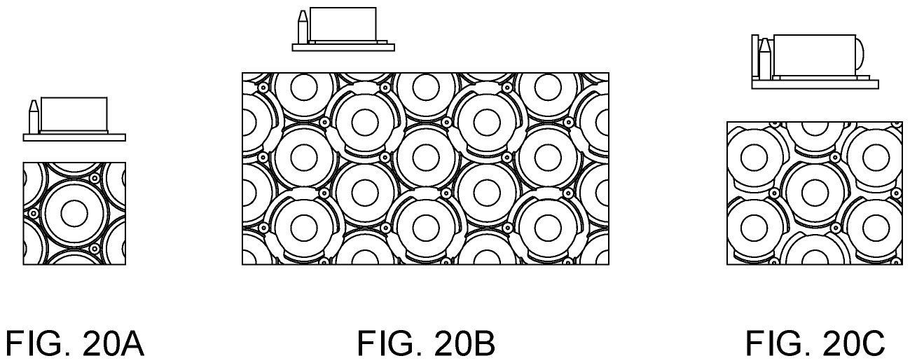

FIG. 20A illustrates an example of a 3-pin arrangement whereby each pin is glued onto the bottom plate in accordance with an embodiment of the disclosure. FIG. 20B illustrates an example of a 3-pin arrangement whereby each pin is applied as part of a 3-pin ring that is glued onto the bottom plate in accordance with an embodiment of the disclosure. FIG. 20C illustrates an example of a 3-pin arrangement whereby each pin is glued to the bottom plate along with glue that is further used to glue the battery cells onto the bottom plate.

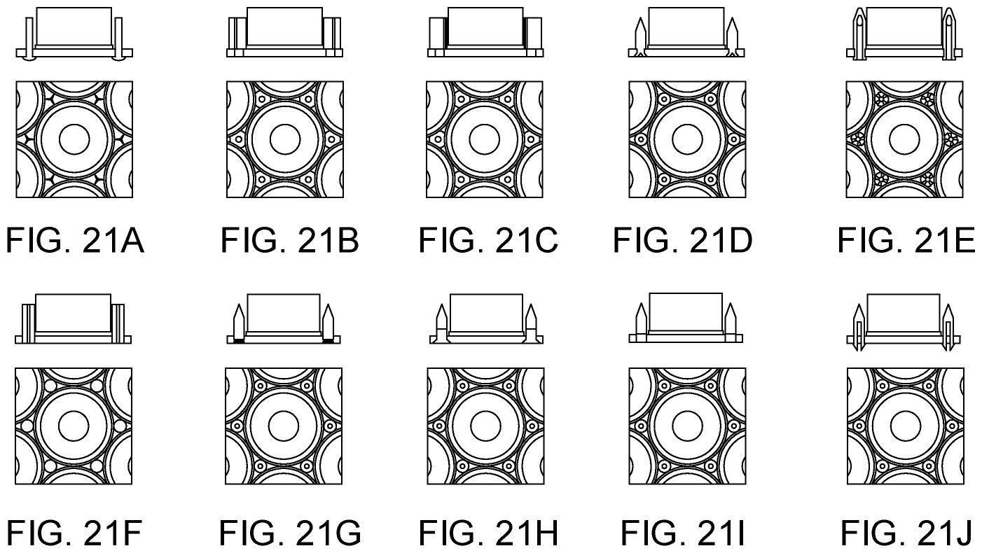

FIGS. 21A-21J illustrates variants in terms of the fit and form of pins in association with a 6-pin arrangement in accordance with embodiments of the disclosure. In particular:

FIG. 21A: staking fit/triangular pin with deformable fins

FIG. 21B: press fit/triangular pin with deformable fins

FIG. 21C: press fit/with deformable three-sided trilobate

FIG. 21D: forming fit/cone-cylinder pin

FIG. 21E: locked dowel fit/cone-cylinder pin

FIG. 21F: press fit/sliced cylinder tube

FIG. 21G: press fit of surrounding part/cone-cylinder pin

FIG. 21H: press in fit/cone-cylinder pin

FIG. 21I: press fit with knurling/cone-cylinder pin

FIG. 21J: clip fit/cone-cylinder pin

In a further embodiment, positioning elements may be implemented an adhesive fit. In other designs, the positioning elements may arranged via a brazing connection, a soldering connection, a welding connection, and so on.

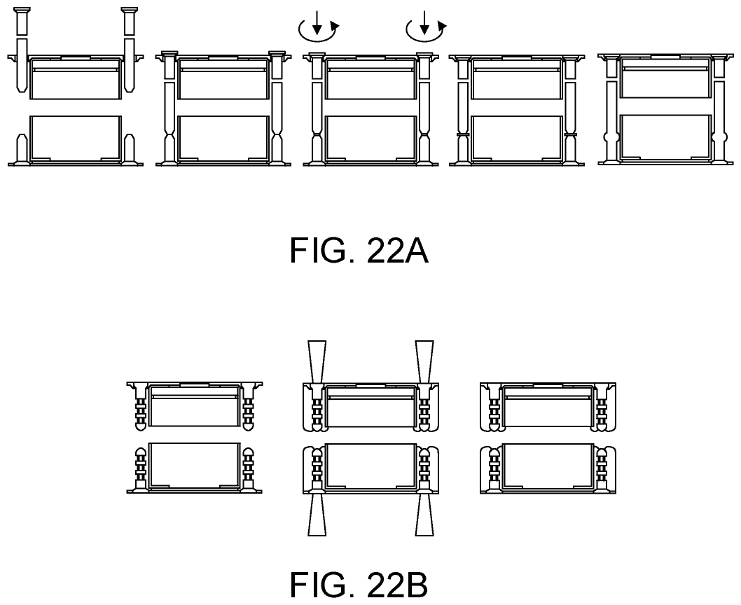

In a further embodiment, the pins may be arranged as tie rods between the top plate and the bottom plate, as shown in FIGS. 22A-22B. In an example, to close the force flux the tie rod connection can applicate as a welded connection by torsional friction welding (e.g., see FIG. 22A) or as a glued connection by glue injection (e.g., see FIG. 22B). In some designs, the pins can further be designed with an opening for dispensing glue. In some designs, a form fit between a ring shaped undercut in the pin can be connected by glue with the cell.

In some designs, the positioning elements can be made from an insulative material (e.g., plastic). In other designs, the positioning elements may comprise a conductive material (e.g., metal). For example, if the bottom plate 1400A is metallic and the positioning elements are defined as indentations defined in the bottom plate 1400A (e.g., by tacking) as shown in FIG. 19(III) for example, then the positioning elements may comprise metal. In some designs, if a conductive material is used, the conductive positioning elements may be coated with an electrically insulative coating. Alternatively, some type of insulative layer (e.g., insulative foil, etc.) may be arranged between the metallic positioning elements and the bottom plate 1400A.

While the embodiments described above relate primarily to land-based electric vehicles (e.g., cars, trucks, etc.), it will be appreciated that other embodiments can deploy the various battery-related embodiments with respect to any type of electric vehicle (e.g., boats, submarines, airplanes, helicopters, drones, spaceships, space shuttles, rockets, etc.).

While the embodiments described above relate primarily to battery module compartments and associated battery modules and insertion-side covers for deployment as part of an energy storage system for an electric vehicle, it will be appreciated that other embodiments can deploy the various battery-related embodiments with respect to any type of energy storage system. For example, besides electric vehicles, the above-noted embodiments can be applied to energy storage systems such as home energy storage systems (e.g., providing power storage for a home power system), industrial or commercial energy storage systems (e.g., providing power storage for a commercial or industrial power system), a grid energy storage system (e.g., providing power storage for a public power system, or power grid) and so on.

As will be appreciated, the placement of the various battery module compartments in the above-noted embodiments is described as being integrated into a vehicle floor of an electric vehicle. However, it will be appreciated that the general closed compartment profile design may be extended to battery module mounting areas that can be installed in other locations within the electric vehicle (e.g., in a trunk of the electric vehicle, behind one or more car seats, under a front-hood of the electric vehicle, etc.).

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A battery module, comprising:
a bottom plate; and
a set of positioning elements integrated into the bottom plate or attached to the bottom plate, the set of positioning elements arranged defining a cell fixation region where a bottom of a cylindrical battery cell interfaces with a surface of the bottom plate.

2. The battery module of claim 1, wherein the set of positioning elements is configured to fix the cylindrical battery cell such that (i) one or more distances between the cylindrical battery cell and one or more adjacent cylindrical battery cells are controlled and (ii) a distance between the bottom of the cylindrical battery cell and a surface of the bottom plate is controlled.

3. The battery module of claim 1, wherein the set of positioning elements comprises between three and six positioning elements arranged circumferentially around the bottom of the cylindrical battery cell.

4. The battery module of claim 1, wherein the set of positioning elements is integrated into the bottom plate.

5. The battery module of claim 4, wherein the set of positioning elements correspond to indentations defined in the bottom plate.

6. The battery module of claim 1, wherein the set of positioning elements is attached to the bottom plate.

7. The battery module of claim 6, wherein the set of positioning elements is attached to the bottom plate via gluing.

8. The battery module of claim 6, wherein the set of positioning elements comprise a set of pins.

9. The battery module of claim 8, wherein the set of pins comprises one or more of:
a triangular pin with deformable pins,
a three-sided trilobite,
a cone-cylinder pin,
a sliced cylinder tube, or
any combination thereof.

10. The battery module of claim 8, wherein the set of pins is attached to the bottom plate via a stake fit, a press fit, a form fit, a locked dowel fit, a clip fit, a material fit, an adhesive fit, or any combination thereof.

11. The battery module of claim 6, wherein the set of positioning elements are integrated into a ring that is attached to the bottom plate.

12. The battery module of claim 6, wherein the set of positioning elements comprise a set of tie rod connections.

13. The battery module of claim 12, wherein the set of tie rod connections are arranged as bolt connections or as welded connections.

14. The battery module of claim 1, wherein the set of positioning elements comprise one or more openings into which glue can be inserted to facilitate attachment of the set of positioning elements to the bottom plate.

15. The battery module of claim 1, wherein at least one positioning element in the set of positioning elements comprises an insulative material.

16. The battery module of claim 1,
wherein at least one positioning element in the set of positioning elements comprises a conductive material, and
wherein the at least one positioning element is coated with an insulative coating.
